(19) United States
(12) Patent Application Publication
(10) Pub. No.: US 2026/0174253 A1
(43) Pub. Date: Jun. 25, 2026

(54) MUSEUM SHOWCASE WITH EASY OPENING

(71) Applicant: GOPPION S.P.A., Trezzano sul Naviglio (IT)

(72) Inventor: Alessandro GOPPION, MILANO (IT)

(21) Appl. No.: 19/417,677

(22) Filed: Dec. 12, 2025

(30) Foreign Application Priority Data
Dec. 19, 2024 (IT) 102024000029217

(51) Int. Cl. A47F 3/04

(52) U.S. Cl. CPC A47F 3/043; A47F 3/0434

(57) ABSTRACT

A museum showcase includes a display space and an opening aid unit. The display space is enclosed in a case with an openable door, which is held in the closed position by a magnetic coupling between a first magnetic element on the case and a second magnetic element on the door. The opening aid unit includes a lever and an abutting element. The lever, mounted on the case, is angularly movable about a pivot axis between a first position and a second position and operable from outside the showcase. The contact end of the lever, in the first position of the lever, interferes with the abutting element to impose a displacement of the door from the case and, in the second position of the lever, does not impose any displacement of the door from the case.

### CROSS-REFERENCE TO RELATED APPLICATIONS

The present application claims priority to Italian patent application No. 102024000029217 filed on Dec. 19, 2024, the contents of which are incorporated herein by reference in their entirety.

### TECHNICAL FIELD

The present disclosure relates to a museum showcase, i.e. a showcase designed and built for the conservation and display in a protected environment of cultural assets, such as works of art, historical exhibits and the like, within the context of a display environment such as a museum, an exhibition or the like. Sometimes, the term showcase alone will be used below for the sake of brevity, although it still means a museum showcase.

### BACKGROUND

A protected environment is defined herein and in the following as an environment in which the possibility of access to unauthorized personnel is prevented, to avoid theft or damage to the objects displayed, and in which preferably the atmosphere can be controlled, by monitoring one or more parameters between temperature, humidity, dust content, pollutant content, in order to maintain the expected conservation conditions of the objects displayed.

Showcases of this type must therefore meet various requirements, in relation to the conservation and integrity of the objects displayed. Furthermore, these showcases must of course ensure the best visibility for the objects displayed.

### SUMMARY

In order to improve visibility, showcase manufacturers try as far as possible to use transparent materials-typically glass-for the walls of the showcase. In addition to ensuring the best visibility of the objects displayed, the extensive use of glass is often desired by showcase designers because the transparency of the material allows the maximum emphasis to be placed on the objects displayed, without the observer being distracted by elements other than the objects displayed in the showcase.

Still in order to improve visibility, as well as to reduce the visual impact of showcase structures that could disturb the proper enjoyment of the objects displayed in the showcase, showcases are common in which an openable door is held in a hermetically sealed position by a perimeter gasket made from a magnetic elastomer; the magnetic attraction is sufficient to hold the openable door against the case, while the elastic deformation of the elastomeric material ensures an airtight sealing. Precisely because sealing is given by the elastic deformation of the gasket, the magnetic attraction must be rather strong, such as to elastically deform the gasket in order to guarantee the sealing.

When the door is to be opened, sufficient force must therefore be exerted thereon to overcome the magnetic attraction on at least three sides of the door in the case of doors hinged on one side or doors with tilt & slide opening, wherein the door opens with an initial angular movement around an upper side of the door (by which the door moves away from the case) followed by a parallel sliding movement on special guides. In the case of showcases with pull & slide opening, wherein the door opens with an initial, more or less parallel movement detaching away from the case, followed by sliding, the magnetic attraction around the entire perimeter of the door must be overcome.

It has been observed that, when a door is grasped and pulled to be opened, a recoil can occur on the case when all sides of the magnetic gasket detach simultaneously. This recoil can generate a dangerous situation for displayed objects, especially if they are particularly delicate or are in a little stable equilibrium.

There is therefore the problem of avoiding the aforesaid risk. The present disclosure solves this problem by means of a showcase according to claim 1; preferred characteristics are given in the dependent claims.

More particularly, a museum showcase according to the present disclosure comprises a display space enclosed in a case closed by an openable door, held in the closed position by a magnetic coupling between a first magnetic element on the case and a second magnetic element on the door, and is characterised by comprising an opening aid unit, which comprises:
a lever, mounted on the case near the door, angularly movable about a pivot axis between a first position and a second position and operable from outside the showcase;
an abutting element, provided on the door near the lever when the door is closed;
   a contact end of the lever, remote from the pivot axis;
wherein the contact end of the lever-in the first position of the lever-interferes with the abutting element so as to impose a displacement of the door from the case, whereas-in the second position of the lever-it does not impose any displacement of the door from the case.

The opening aid unit, thanks to the lever and the abutting element, allows for a smooth opening of the door by applying a force between the door and the case. When the magnetic elements are detached, even if they are very extended and exert a high closing force, as is the case for magnetic gaskets extended along the entire perimeter of the door, there is no recoil on the case, and the risk of causing excessive jolts or vibrations to the showcase is therefore avoided, thus preventing potential damage to displayed objects. In addition, the opening operation is easy and requires only a minimal force by the operator. Furthermore, even if the door is devoid of any handles (as is normally the case, in order to minimise the aesthetic impact), it is possible to open the door without having to resort to the help of a suction cup, to pull the door in the opening direction.

In the second position, the lever can have its contact end against the abutting element, without however pushing thereon, or it can be distanced from the abutting element. When the lever moves from its second position to its first position, its contact end pushes progressively on the abutting element, separating the door from the case.

Preferably, the contact end is formed by a rolling feeler.

The rolling feeler facilitates the movement of the lever, minimising friction between the contact end and the abutting element.

Preferably, the abutting element has such a shape that the displacement imposed by the engagement with the contact end increases progressively from zero to a maximum value when the lever moves from its second to its first position.

The profile of the abutting element can be shaped so that a given angular displacement of the lever corresponds to a consequent displacement of the door relative to the case of the showcase.

Preferably, the abutting element has a profile—viewed in a plane orthogonal to the pivot axis of the lever—extended according to an arc of circumference having concavity facing the lever and a radius greater than an arm of the lever between the pivot axis and the contact end.

Such a profile is easy to achieve and ensures the desired smoothness of actuation.

By appropriately choosing the profile radius and the lever arm, it is possible to obtain the most suitable opening mode for each specific showcase.

For example, with the same lever arm, the smaller the radius of the profile, the smoother the actuation, and the smaller the maximum displacement that is imposed on the door relative to the case. Again, for the same profile radius, the smaller the lever arm, the smoother the actuation, and the smaller the maximum displacement that is imposed on the door relative to the case.

For special requirements, then, a profile other than a simple circular arc can be adopted, e.g. to ensure that the displacement of the door is extremely small at the initial angular displacement of the lever from its second position towards its first position, so that the detachment between the magnetic elements during the opening of the door is particularly smooth.

It is also possible for the profile to be extended along a straight section, i.e. along an arc of circumference having an infinite radius.

Preferably, the lever is mounted rotatably integral with a tang, which is rotatably mounted in a seat provided in the case along the pivot axis, the tang being provided with a driving end having non-circular symmetry, accessible from outside the showcase to be coupled with a driving tool.

The driving tool can be a lever permanently attached to the tang, or it can be an external tool, removable from the showcase when not in use.

In one embodiment, the door is hinged to the case at a hinge edge thereof, and the opening aid unit is located at an edge of the case other than the hinge edge.

The edge at which the opening aid unit is placed can be the one opposite the hinge edge, or even one of the two adjacent edges. Especially in the frequent case wherein the hinge edge is vertical, the opening aid unit can be usefully placed at the lower edge of the case, so that it can be easily hidden from view.

In another embodiment thereof, the showcase is of the tilt & slide or pull & slide type and comprises an additional opening aid unit, equal to the opening aid unit, wherein the additional opening aid unit is connected to the opening aid unit by a kinematic mechanism that synchronises the movement of the respective levers.

The provision of two synchronised opening aid units allows for easy actuation and ensures a smooth opening of a pull & slide openable door.

Preferably, the opening aid unit comprises a further abutting element on the door, extended opposite to the abutting element, wherein the contact end is protruding from the lever in a direction parallel to the pivot axis and engages between the abutting element and the further abutting element, and the abutting element and the further abutting element are shaped so as to impose the closing of the door at the second lever position and the opening of the door at the first lever position

The closing operation of the door is normally less critical than the opening operation. However, even during closing, it is possible that recoil may occur on the showcase, due to the action of the magnetic elements, which—when their distance is small enough—may cause the door to close abruptly. The additional abutting element avoids this problem, as it controls the closing movement of the door in a way similar to the abutting element during the opening movement.

In one embodiment, the door is a glass door.

In fact, the problem of possible recoil on the case when opening the showcase is particularly evident with glass doors, wherein the weight of the door is high and therefore it is necessary for the magnetic elements to exert a relatively high force to hold the door closed.

### DESCRIPTION OF THE DRAWINGS

Further features and advantages of the present disclosure will be more evident from the following description of preferred embodiments thereof made with reference to the appended drawings. In such drawings:

FIG. 1 is a perspective view of a showcase according to the present disclosure, with the door fully open;

FIG. 2 is a perspective view of the showcase of FIG. 1, with the door slightly opened;

FIG. 3 is an enlarged scale view of the detail A of FIG. 2;

FIG. 4 is a cross-section view in a horizontal plane of the showcase of FIG. 1, with the door open;

FIG. 5 is a cross-section view in a horizontal plane of the showcase of FIG. 1, provided with a driving tool, with the door slightly opened;

FIG. 6 is an enlarged scale view of the detail B of FIG. 5;

FIG. 7 is a section view in a horizontal plane of the showcase of FIG. 1, with the door closed;

FIG. 8 is an enlarged scale view of the detail C of FIG. 7;

FIG. 9 is a cross-section view in a vertical plane of a detail of the showcase of FIG. 1, with the door slightly opened;

FIG. 10 is a section view in a horizontal plane of a variant of the showcase according to the present disclosure, with the door slightly opened;

FIG. 11 is an enlarged scale view of the detail D of FIG. 10.

FIG. 12 is an enlarged scale view of the detail E of FIG. 10.

### DETAILED DESCRIPTION

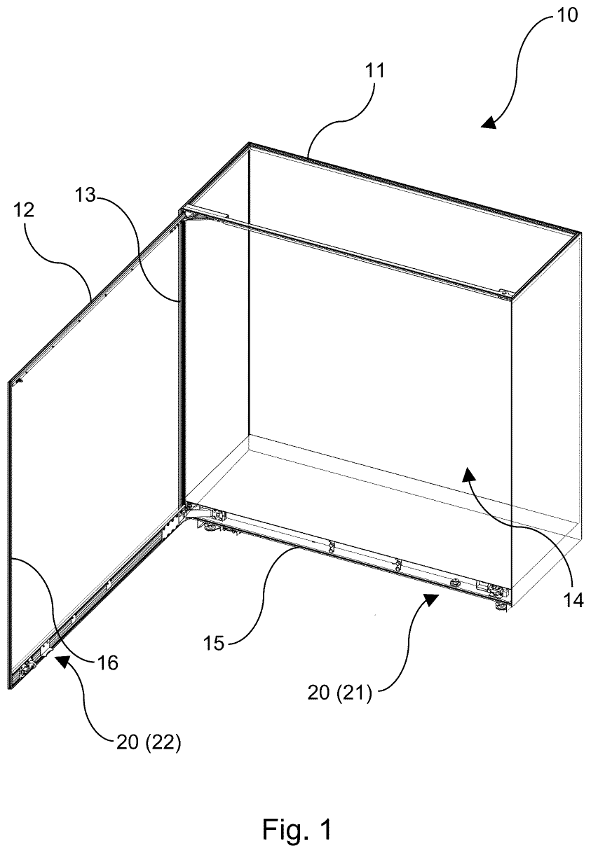

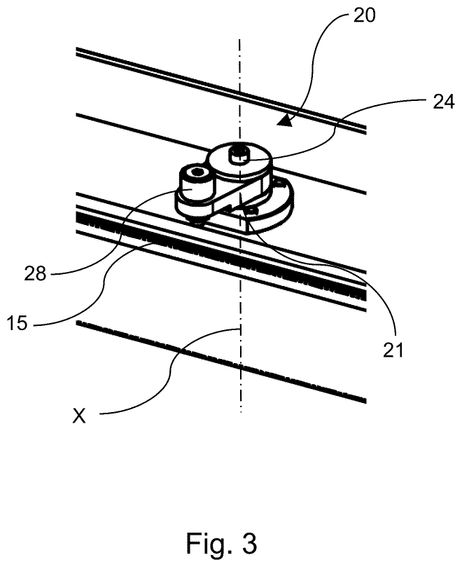

FIGS. 1 to 9 show a showcase 10 comprising a fixed case 11 and a hinged openable door 12, in particular a glass door 12, hinged to the case 11 along a vertical hinge edge 13. A display space 14 is defined within the case 11. The showcase 10 then comprises a pair of magnetic elements that mutually attract to hold the door 12 in the closed position; these magnetic elements comprise a magnetic gasket 15 mounted on the case 11 and a corresponding metal abutment 16 mounted on the perimeter of the door 12.

The showcase 10 then comprises an opening aid unit 20, located at an edge 17 of the case 11 other than the hinge edge 13. The opening aid unit 20 is formed by a lever 21 on the case 11 and an abutting element 22 on the door 12. The abutting element 22 is provided on the door 12 in a position which—when the door 12 is closed—is close to the lever 21. The lever 21 is mounted on the case 11 so as to be angularly movable relative to the case 11 about a pivot axis X, so that it can assume a first and a second position, spaced apart from each other by approximately 90°. To this end, the lever 21 is mounted rotatably integral on a cylindrical tang 24, which is extended along the pivot axis X and is inserted into a corresponding seat 25 formed in the case 11.

The lever 21 is drivable from outside the showcase 10; for this purpose, the tang 24 is provided with a driving end 26 having non-circular symmetry, accessible from outside the showcase 10 so that it can be coupled to a driving tool 27.

The lever 21 is provided with a contact end 28, spaced from the pivot axis X. Preferably, the contact end 28 is protruding from the lever 21 in a direction parallel to the pivot axis X; preferably, the contact end 28 is formed by a rolling feeler.

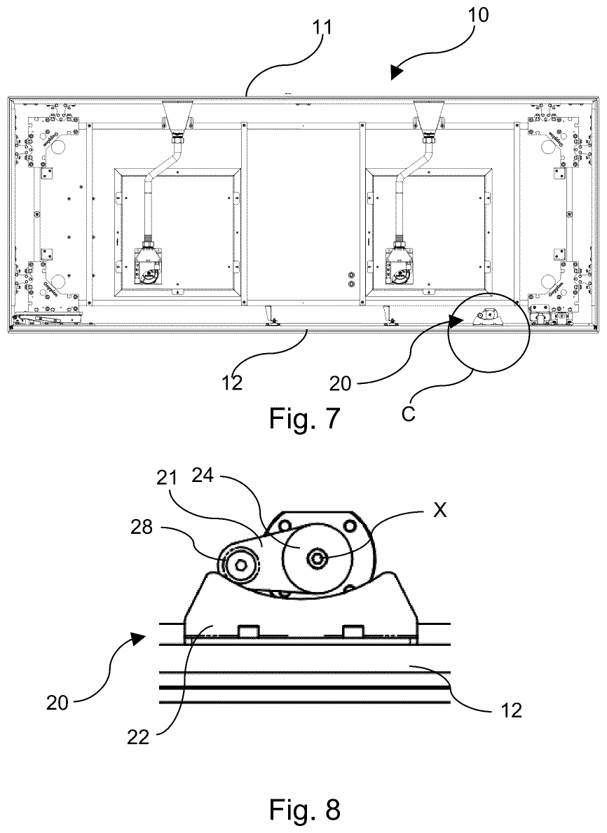

When the lever 21 is in its first position, visible in FIGS. 1-6 and 9, the contact end 28 interferes with the abutting element 22 to the extent that it pushes it out from the case 11 and thus imposes a displacement of the door 12 from the case 11. When, on the other hand, the lever 21 is in its second position, visible in FIGS. 7 and 8, the contact end 28 does not impose any displacement of the door 12 from the case 11; in this second position of the lever 21, the contact end 28 may also not be in contact with the abutting element 22, or—as shown in the figures—be in contact with it without, however, exerting any outward thrust relative to the case 11.

The operation of the opening aid unit 20 for opening the door 12 of the showcase 10 is evident from its structure and will be further described hereinafter.

When the door 12 is closed, the showcase is in the condition visible in FIGS. 7 and 8. The lever 21 of the opening aid unit 20 is in its second position and, as visible in FIG. 8, the contact end 28 rests on the abutting element 22 but does not exert any thrust thereon. As a result, the magnetic gasket 15 and the abutment 16 hold the door 12 in close contact with the case 11, so that the showcase 10 remains closed.

When the door 12 is to be opened, the lever 21 must be actuated. To do this, it is possible to use the driving tool 27 engaging it on the driving end 26 of the tang 24, from outside the showcase 10. By acting on the driving tool 27, the lever 21 is angularly displaced from its second to its first position. During this movement, the contact end 28 progressively pushes on the abutting element 22 and thus opens the door 12 separating the magnetic gasket 15 from the abutment 16. Thanks to the progressive thrust of the lever 21, the detachment between the two magnetic elements 15 and 16 occurs smoothly, without jolts that would cause significant vibrations of the case 11.

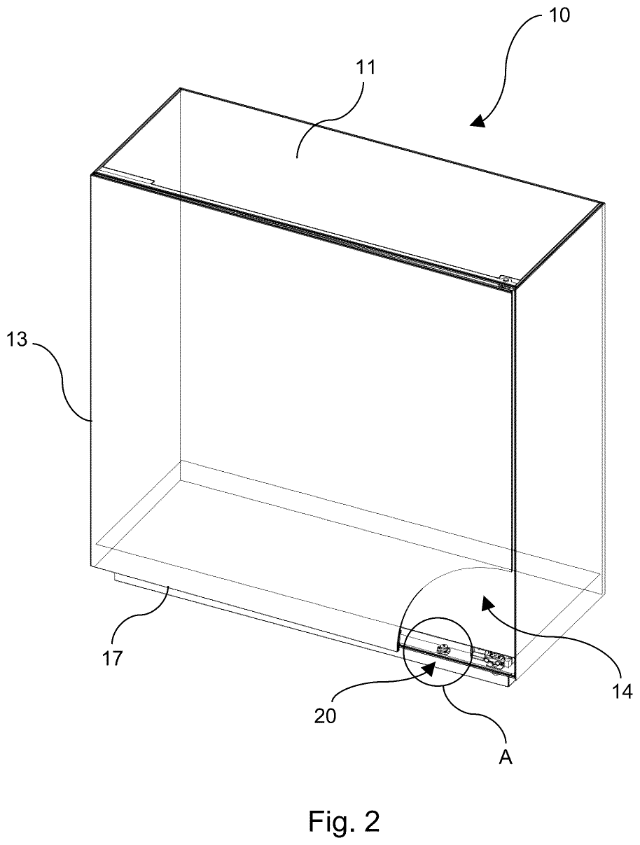

The abutting element 22 has a profile such that the displacement imposed on the door 12 relative to the case 11 ranges from zero (when the lever 21 is in its second position) to a maximum value (when the lever 21 is in its first position) which corresponds to a position of the door 12 just slightly displaced from the case 11, just enough to ensure that the abutment 16 is completely detached from the magnetic gasket 15. This position of the door 12 is shown in FIGS. 2, 5, 6 and 9.

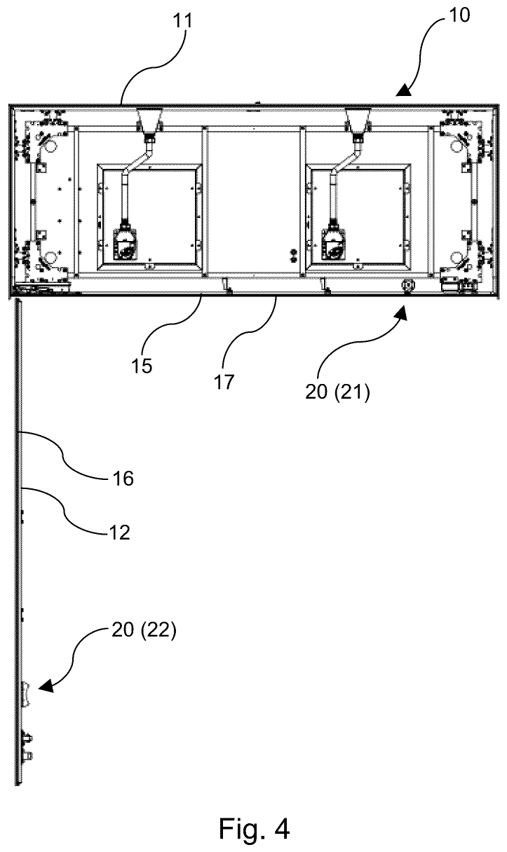

After the door 12 has been brought to this position by the action of the lever 21, its full opening (visible in FIGS. 1 and 4) is simply achieved by moving the door 12 by hand. Since the door 12 is no longer held by the magnetic coupling between the magnetic gasket 15 and the abutment 16, no jolts are induced on the case 11 during this displacement.

In order to close the door 12, simply return the lever 21 to its second position and then push the door 12 against the case 11; the magnetic attraction action between the gasket 15 and abutment 16 is then such as to hold the door 12 and thus hold the showcase 10 closed.

The desired progressiveness in the opening of the door 12 by the lever 21 is defined by appropriately shaping the abutting element 22. In a preferred embodiment, clearly visible in FIGS. 6 and 8, the abutting element 22 has a profile extended in a plane orthogonal to the pivot axis X according to an arc of circumference with the concavity facing the lever 21 and a radius greater than the arm of the lever 21, which is equal to the distance between the pivot axis X and the contact end 28.

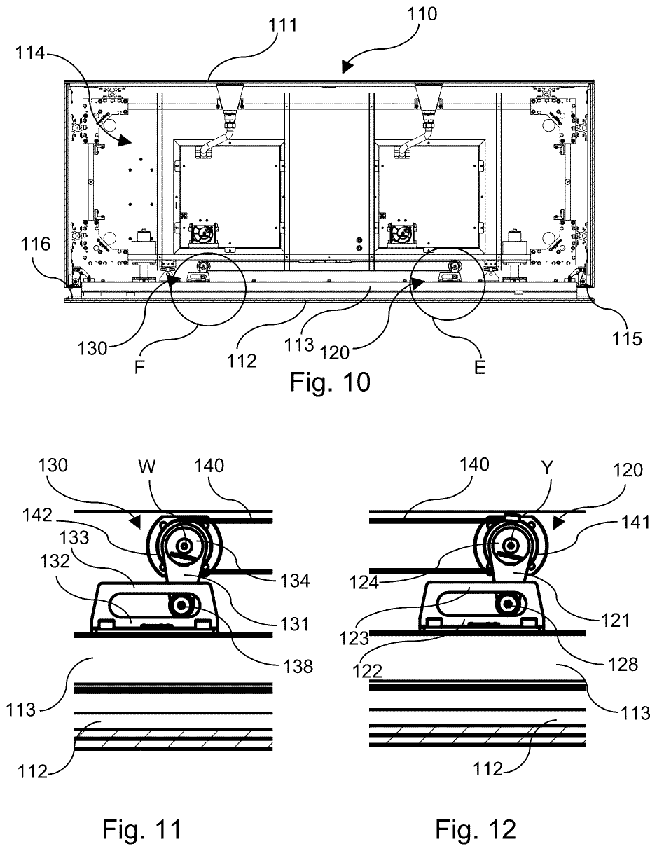

In FIGS. 10 to 12, another showcase 110 according to the present disclosure is shown. The showcase 110, compared to the showcase 10 just described, differs in the presence of certain optional features of the present disclosure that are described hereinafter; otherwise, it is similar to the showcase 10.

The showcase 110 comprises a case 111 and a door 112 that can be opened by pulling and sliding: while opening it, there is an initial displacement of the door 112 from the case 111, followed by a horizontal sliding of the door 112 into its own plane. An example of a showcase with this type of opening is described in WO 2015/111009.

The door 112 is then supported, along its upper horizontal edge, by a guide hinged to the case 111, not visible in the figures, and comprises at the bottom a rectilinear guide 113; during the opening of the door 112, it is first displaced from the case 111 by moving the guide 113 outwards, then it is slid horizontally on the guide 113 which remains stationary, in front of the case 111. A display space 114 is defined within the case 111. The showcase 110 then comprises a pair of magnetic elements that mutually attract to hold the door 112 in the closed position; these magnetic elements comprise a magnetic gasket 115 mounted on the case 111 and a corresponding metal abutment 116 mounted on the perimeter of the door 112.

The showcase 110 then comprises an opening aid unit 120 and a further opening aid unit 130, equal to the opening aid unit 120. Both opening aid units 120 and 130 are arranged at the same lower edge of the case 111, spaced from each other.

The opening aid unit 120 is formed by a lever 121 on the case 111, an abutting element 122 on the guide 113 of the door 112 and a further abutting element 123, also on the guide 113 of the door 112. The abutting elements 122 and 123 are provided on the guide 113 of the door 112 in a position which—with the door 112 closed—is close to the lever 121. The lever 121 is mounted on the case 111 so as to be angularly movable relative to the case 111 about a pivot axis Y, so that it can assume a first and a second position, spaced apart from each other by approximately 90°. To this end, the lever 121 is mounted rotatably integral on a cylindrical tang 124, which is extended along the pivot axis Y and is inserted into a corresponding seat formed in the case 111 (not visible in the figures but analogous to the seat 25 of the case 10).

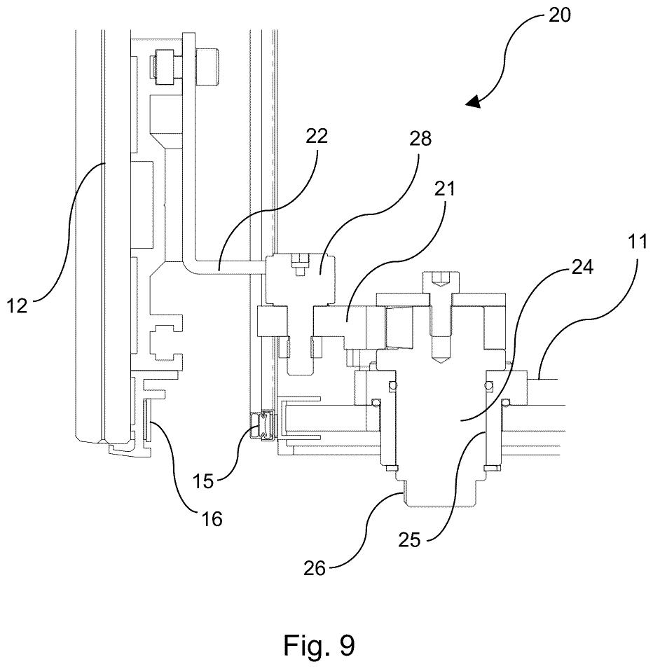

Similarly, the opening aid unit 130 is formed by a lever 131 on the case 111, an abutting element 132 on the guide 113 of the door 112 and a further abutting element 133, also on the guide 113 of the door 112. The abutting elements 132 and 133 are provided on the guide 113 of the door 112 in a position which—with the door 112 closed—is close to the lever 131. The lever 131 is mounted on the case 111 so as to be angularly movable relative to the case 111 about a pivot axis W, parallel to the pivot axis Y, so that it can assume a first and a second position, spaced apart from each other by approximately 90°. To this end, the lever 131 is mounted rotatably integral on a cylindrical tang (not visible in the figures but analogous to the tang 124 of the lever 121), which is extended along the pivot axis W and is inserted into a corresponding seat formed in the case 111 (not visible in the figures but analogous to the seat 25 of the case 10, visible in FIG. 9).

The two opening aid units 120 and 130 are connected to each other by a kinematic mechanism, so that the movement of the respective levers 121 and 131 is synchronised, i.e. so that the two levers 121 and 131 move angularly together and by equal angles; in particular, when one of the two levers 121 and 131 is in its first position, the other one is also in its first position, and when one of the two levers 121 and 131 is in its second position, the other one is also in its second position. This kinematic mechanism comprises, for example, a closed belt 140, wound on two wheels 141 and 142, integral in rotation to the levers 121 and 131, as visible in FIGS. 11 and 12.

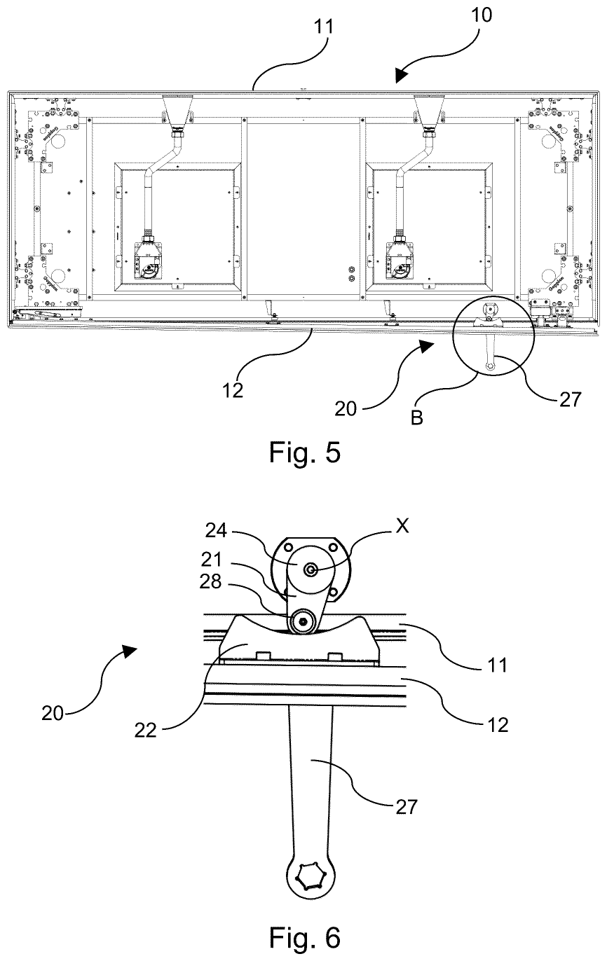

The lever 121 is operable from outside the showcase 110; to this end, the tang 124 is provided with a driving end having non-circular symmetry (not visible in the figures but entirely analogous to the driving end 26, visible in FIG. 9), which is accessible from outside the showcase 110 so as to be coupled to a driving tool (not visible in the figures but entirely analogous to the tool 27 visible in FIGS. 5 and 6). The belt 140 ensures that when the lever 121 is actuated, the lever 131 is also actuated synchronously.

The lever 121 and the lever 131 are provided with respective contact ends 128 and 138, spaced from the pivot axis Y and the pivot axis W, respectively. The contact ends 128 and 138 are protruding from the respective levers 121 and 131 in a direction parallel to the pivot axes Y and W; preferably, the contact ends 128 and 138 are formed by rolling feelers.

The abutting elements 122 and 123 are positioned on the guide 113 opposite to each other and the contact end 128 of the lever 121 is positioned between them with a clearance, in a condition of substantial sliding contact against both of them. Similarly, the abutting elements 132 and 133 are positioned on the guide 113 opposite to each other and the contact end 138 of the lever 131 is positioned between them with a clearance, in a condition of substantial sliding contact against both of them.

When the lever 121 and the lever 131 are in their first position, as visible in FIGS. 10 and 11, the contact ends 128 and 138 interfere with the abutments 122 and 132 to the extent that they push the guide 113 outwards relative to the case 111 and thus impose a parallel displacement of the lower edge of the door 112 from the case 111; this parallel displacement is necessary to allow the door 112 to slide, once the door 112 has been displaced from the case 111. When, on the other hand, the levers 121 and 131 are moved to their second position (not visible in the figures), the contact ends 128 and 138 not only impose no displacement of the guide 113 (and therefore of the door 112) from the case 111, but also push on the additional abutments 123 and 133, forcing the guide 113 (and therefore the door 112) towards the case 111, until the door 112 reaches its fully closed position.

The operation of the opening aid units 120 and 130 for opening the door 112 of the showcase 110 is similar to the one of the opening aid unit 20 of the showcase 10, as far as the step of opening the showcase is concerned.

When the door 112 is closed, the levers 121 and 131 are in their second position and the contact ends 128 and 138 rest on the abutting elements 122 and 132, without exerting any thrust. Consequently, the magnetic gasket 115 and abutment 116 hold the door 112 in close contact with the case 111, so that the showcase 110 remains closed.

When the door 112 is to be opened, the levers 121 and 131 must be actuated to move them angularly from the second to the first position. During this movement, the contact ends 128 and 138 progressively push on the abutting elements 122 and 132 and then push out the guide 113, opening the door 112 and separating the abutment 116 from the magnetic gasket 115. Thanks to the progressive thrust of the levers 121 and 131, the detachment between the two magnetic elements 115 and 116 occurs smoothly, without any jolts that would cause significant vibrations of the case 111.

The abutments 122 and 132 have such a profile that the displacement imposed on the guide 113 of the door 112 relative to the case 111 goes from zero (when the levers 121 and 131 are in the second position) to a maximum value (when the levers 121 and 131 are in the first position) which corresponds to a position of the door 112 just slightly displaced from the case 111, just enough to ensure that the abutment 116 is completely detached from the magnetic gasket 115. This position of the door 12 is shown in FIGS. 10, 11 and 12.

Once the door 112 has been detached from the case 111 (and has thus reached the position shown in FIGS. 10, 11 and 12), it can be fully opened by simply sliding it on its guide 113. Since the door 112 is no longer held by the magnetic coupling between the magnetic gasket 115 and the abutment 116, no jolts are induced on the case 111 during this displacement.

The desired progressiveness in the opening of the door 112 by the levers 121 and 131 is defined by appropriately shaping the abutting elements 122 and 132. In a particularly simple embodiment, visible especially in FIGS. 11 and 12, the abutting elements 122 and 132 have a profile extended according to a straight segment in a plane orthogonal to the pivot axes Y and W.

As seen, in the showcase 110 with pull & slide opening, the present disclosure has some optional features that differ from the showcase 10. The presence of two opening aid units instead of one and the presence of an additional abutting element that facilitates closing are specifically adapted to the showcase 110 that has this type of opening. On the other hand, it is clear that the straight instead of arched profile of the abutting element can also be used on a hinged showcase.

1. A museum showcase comprising:
a display space enclosed in a case with an openable door, the openable door held in the closed position by a magnetic coupling between a first magnetic element on the case and a second magnetic element on the door, and
an opening aid unit, the opening aid unit comprising:
a lever, mounted on the case, angularly movable about a pivot axis between a first position and a second position and operable from outside the showcase;
an abutting element provided on the door near the lever when the door is closed;
and
a contact end of the lever, remote from the pivot axis;
wherein the contact end of the lever, in the first position of the lever, interferes with the abutting element to impose a displacement of the door from the case, and the contact end of the lever, in the second position of the lever, does not impose any displacement of the door from the case.

2. The museum showcase according to claim 1, wherein the contact end is formed by a rolling feeler.

3. The museum showcase according to claim 1, wherein the abutting element is configured so that the displacement imposed by the engagement with the contact end increases progressively from zero to a maximum value when the lever moves from the second position to the first position.

4. The museum showcase according to claim 1, wherein the abutting element has a profile, viewed in a plane orthogonal to the pivot axis of the lever, extended according to an arc of circumference having concavity facing the lever and a radius greater than an arm of the lever between the pivot axis and the contact end.

5. The museum showcase according to claim 1, wherein the lever is mounted rotatably integral with a tang, which is rotatably mounted in a seat provided in the case along the pivot axis, the tang being provided with a driving end having non-circular symmetry and configured to be accessible from outside the showcase and to be coupled to a driving tool.

6. The museum showcase according to claim 1, wherein the door is hinged to the case at a hinge edge, and wherein the opening aid unit is located at an edge of the case other than the hinge edge.

7. The museum showcase according to claim 1, further comprising a pull and slide opening, the pull and slide opening comprising a second opening aid unit, wherein the second opening aid unit is connected to the opening aid unit by a kinematic mechanism that synchronises the movement of the respective levers.

8. The museum showcase according to claim 7, wherein the opening aid units each comprise a further abutting element on the door, extended opposite the abutting element, wherein the contact end protrudes from the lever in a direction parallel to the pivot axis and engages between the abutting element and the further abutting element, and wherein the abutting element and the further abutting element are configured to impose the closing of the door at the second position of the lever and the opening of the door at the first position of the lever.

9. The museum showcase according to claim 1, wherein the door is a glass door.
